(19) United States
(12) Patent Application Publication
(10) Pub. No.: US 2025/0083245 A1
(43) Pub. Date: Mar. 13, 2025

(54) WELDING ASSEMBLIES AND METHODS

(71) Applicant: Innovative Weld Solutions L.L.C., Rochester, MI (US)

(72) Inventor: Venkatasubramanian Ananthanarayanan, Rochester, MI (US)

(73) Assignee: Innovative Weld Solutions L.L.C., Rochester, MI (US)

(21) Appl. No.: 18/291,648

(22) PCT Filed: Jul. 29, 2022
(86) PCT No.: PCT/US2022/074290

§ 371 Date: Jan. 24, 2024

Related U.S. Application Data
(60) Provisional application No. 63/243,278, filed on Sep. 13, 2021.

(51) Int. Cl. B23K 9/00

(52) U.S. Cl. CPC B23K 9/0026

(57) ABSTRACT

A method for welding includes (1) assembling a workpiece comprising a first member and a second member; (2) positioning a first electrode proximate the first member and a second electrode proximate the second member, the first electrode being moveable relative to the second electrode; (3) positioning a shunt member between the first and the second electrode; (4) clamping the workpiece between the first and the second electrode; and (5) during the clamping, passing a welding current between the first and the second electrode, wherein, while the welding current is passing between the first electrode and the second electrode, the first electrode moves relative to the second electrode from at least a first position, wherein a gap is defined between the shunt member and the second electrode, to a second position, wherein the gap is closed and at least a portion of the welding current passes through the shunt member.

### PRIORITY

This application claims priority from U.S. Ser. No. 63/243,278 filed on Sep. 13, 2021, the entire contents of which are incorporated herein by reference.

### FIELD

The present disclosure is generally related to welding apparatus, systems, and methods and, more particularly, to resistance welding assemblies and methods for welding metal and metal alloy stranded cables or wires.

### BACKGROUND

Stranded metals and metal alloys (e.g., stranded cables and wires) find a wide variety of applications. Particularly, stranded aluminum and aluminum alloys find a wide variety of applications due to their favorable combination of electrical conductivity properties and mechanical properties, including strength-to-weight ratio, low temperature (cryogenic) properties, corrosion resistance and notch toughness.

The challenge with stranded aluminum and aluminum alloys is joining (by welding) the stranded cables or wires to one another and/or to a connector. During a welding operation (e.g., resistive welding), individual strands of the cable or wire may not consistently liquefy to form a solid welded workpiece. For example, strands located proximate the periphery of the cable or wire may liquefy; while strands located proximate the center of the cable or wire may not liquefy sufficiently to form a suitably solid weld. In order to sufficiently liquefy strands proximate the center of the cable or wire, the strands located proximate the periphery of the cable or wire may tend to burn and the whole welded assembly may tend to stick to the weld electrodes.

Accordingly, those skilled in the art continue with research and development efforts in the field of welding stranded metals and metal alloys.

### SUMMARY

Disclosed are examples of a method for welding and a welding assembly. The following is a non-exhaustive list of examples, which may or may not claimed, of the subject matter according to the present disclosure.

In an example, the disclosed method for welding includes steps of: (1) assembling a workpiece comprising a first member and a second member; (2) positioning a first electrode proximate the first member and a second electrode proximate the second member, the first electrode being moveable relative to the second electrode; (3) positioning a shunt member between the first electrode and the second electrode; (4) clamping the workpiece between the first electrode and the second electrode; and (5) during the clamping, passing a welding current between the first electrode and the second electrode, wherein, while the welding current is passing between the first electrode and the second electrode, the first electrode moves relative to the second electrode from at least a first position, wherein a gap is defined between the shunt member and the second electrode, to a second position, wherein the gap is closed and at least a portion of the welding current passes through the shunt member.

In another example, the disclosed method includes steps of: (1) positioning a workpiece between a first electrode and a second electrode; (2) moving the first electrode and the second electrode toward each other; (3) passing a welding current through the workpiece; (4) further moving the first electrode and the second electrode toward each other; and (5) passing a portion of the welding current directly between the first electrode and the second electrode.

In an example, the disclosed welding assembly includes a current generator; a first electrode electrically coupled to the current generator; a second electrode electrically coupled to the current generator; and a shunt member located between the first electrode and the second electrode, wherein the first electrode is moveable relative to the second electrode between at least a first position and a second position, wherein the shunt member is electrically isolated from the second electrode when the first electrode is in the first position, and wherein the shunt member is electrically coupled with both the first electrode and the second electrode when the first electrode is in the second position.

Other examples of the disclosed welding assemblies and methods will become apparent from the following detailed description, the accompanying drawings, and the appended claims.

### BRIEF DESCRIPTION OF THE DRAWINGS

FIG. 1 is a flowchart of an example of a method for welding;

FIG. 2 is a schematic illustration of an example of a welding assembly;

FIG. 3 is a schematic, side elevational view of an example of the welding assembly;

FIG. 4 is a schematic, side elevational view, in section, of an example of a portion of a workpiece being welded by the welding assembly of FIG. 3;

FIG. 5 is a schematic, side elevational view, in section, of an example of a portion of a workpiece being welded by the welding assembly of FIG. 3;

FIG. 6 is a schematic, side elevational view, in section, of an example of a portion of a workpiece welded by the welding assembly of FIG. 3;

FIG. 7 is a schematic, side elevational view of an example of a portion of a workpiece being welded by the welding assembly of FIG. 3;

FIG. 8 is a schematic, side elevational view of an example of a portion of a workpiece being welded by the welding assembly of FIG. 3;

FIG. 9 is a schematic, side view, in section, of an example of the welding assembly, shown in a first position;

FIG. 10 is a schematic, side view, in section, of an example of the welding assembly, shown in a first position;

FIG. 11 is a schematic, side view, in section, of an example of the welding assembly, shown in a first position;

FIG. 12 is a schematic, side view, in section, of an example of the welding assembly of FIG. 9, shown in a second position;

FIG. 13 is a schematic, side view, in section, of an example of the welding assembly of FIG. 10, shown in a second position;

FIG. 14 is a schematic, side view, in section, of an example of the welding assembly of FIG. 11, shown in a second position;

FIG. 15 is a schematic, side view, in section, of an example of the welding assembly shown in a first position;

FIG. 16 is a schematic, side elevational view of an example of a portion of a workpiece being welded by the welding assembly of FIG. 3;

FIG. 17 is a schematic, side view, in section, of an example of the welding assembly, shown in a first position;

FIG. 18 is a schematic, perspective view of a portion of a width-determining fixture of the welding assembly;

FIG. 19 is a schematic, top plan view, in partial section, of an example of a portion of a workpiece being welded by the welding assembly;

FIG. 20 is a schematic, top plan view, in partial section, of an example of a portion of a workpiece welded by the welding assembly;

FIG. 21 is a schematic, side view, in section, of an example of the welding assembly, shown in a first position; and

FIG. 22 is a schematic, side view, in section, of an example of the welding assembly of FIG. 21, shown in a second position.

### DETAILED DESCRIPTION

The following detailed description refers to the accompanying drawings, which illustrate specific examples of the disclosure. Other examples having different structures and operations do not depart from the scope of the present disclosure. Like reference numerals may refer to the same element or component in the different drawings.

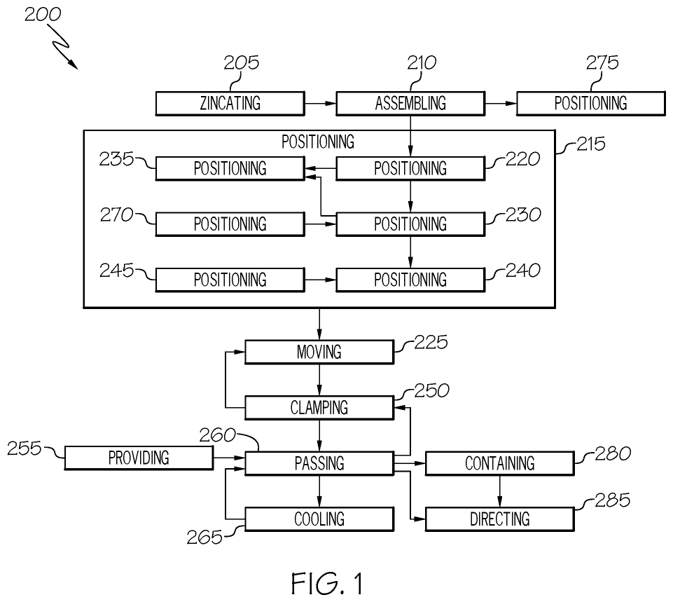

Referring to FIG. 1, disclosed is a method 200 for welding. In one or more examples, the method 200 is for welding stranded metals or stranded metal alloys. As an example, the method 200 facilitates welding of a stranded metal or stranded metal alloy to another stranded metal or stranded metal alloy. As another example, the method 200 facilitates welding of a stranded metal or stranded metal alloy to a metal structure or metal alloy structure.

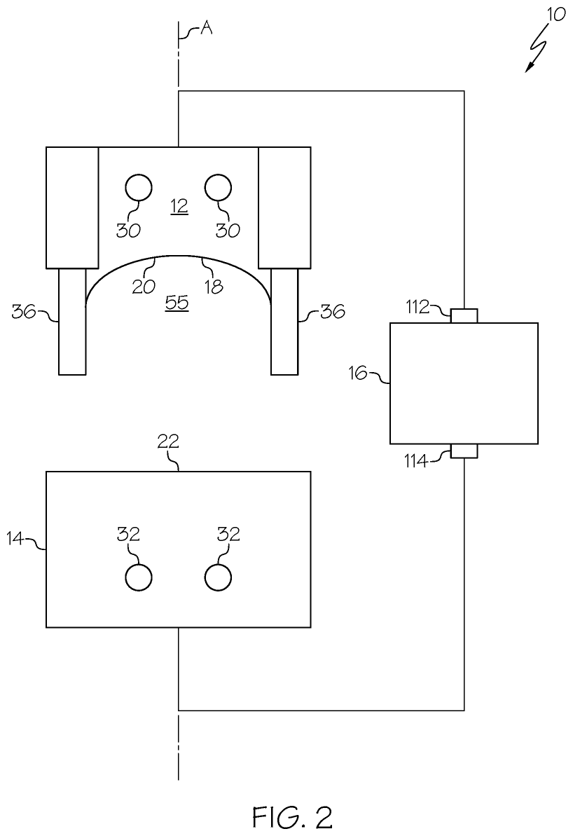

In one or more examples, the method 200 may be carried out or otherwise implemented using a welding assembly 10 (e.g., as shown in FIGS. 2-22).

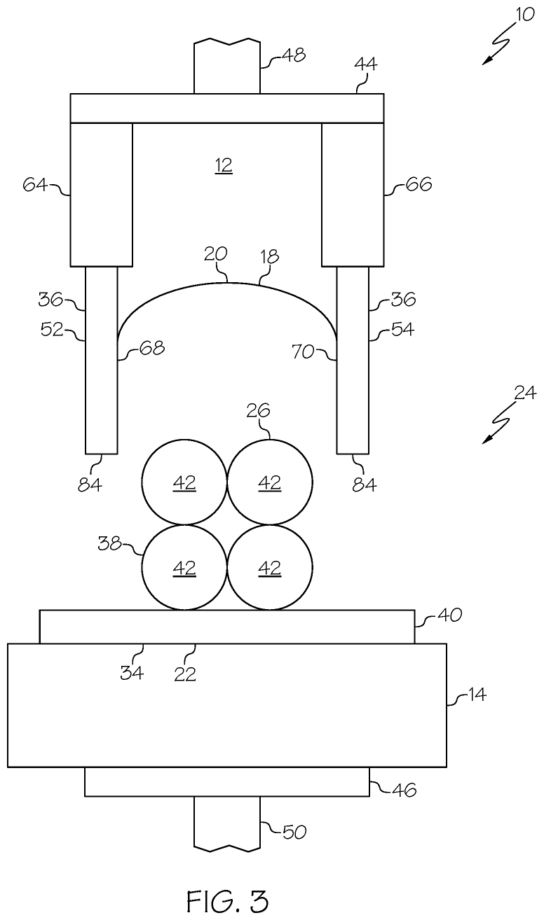

Referring still to FIG. 1, in one or more examples, the method 200 includes a step of assembling 210 a workpiece 24. Generally, the workpiece 24 includes two or more members intended to be joined by welding, for example, by resistive welding. In one or more examples, the workpiece 24 includes a first member 38 and a second member 40 (e.g., as shown in FIGS. 3, 4, 9-15, 17 and 19).

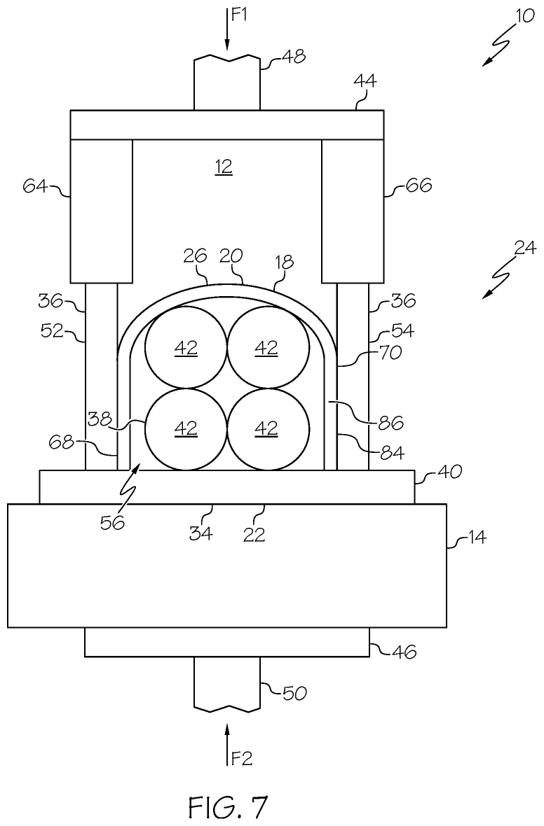

In other examples, the workpiece 24 includes one or more additional members (e.g., an auxiliary member 84 as shown in FIGS. 7, 8 and 16). In one or more examples, the method 200 includes a step of positioning 275 the auxiliary member 84 around a portion of the first member 38. In one or more examples, the step of positioning 275 the auxiliary member 84 around a portion of the first member 38 is performed during or forms a portion of the step of assembling 210 the workpiece 24.

In one or more examples, the first member 38 includes or takes the form of a plurality of strands 42 bundled together. The bundle of strands 42 may have a generally circular cross-sectional shape. In one or more examples, the first member 38 may also include a sheathing 90 that covers or otherwise surrounds at least a portion of the strands 42. As an example, the first member 38 is a wire, a cable, or a rope of stranded metal or stranded metal allow. As a specific example, the first member 38 may be a 25 mm², 40 mm² or 50 mm² stranded wire cable. The workpiece 24, such as at least the first member 38, may include a metal or a metal alloy, such as aluminum, aluminum alloy, copper, brass, tin, or a combination thereof.

In one or more examples, second member 40 includes or takes the form of a terminal to which the first member 38 (e.g., stranded cable or wire) is to be joined by welding. As an example, the second member 40 may be a connector terminal for connection (e.g., mechanical and/or electrical connection) to another object or structure. In other examples, second member 40 includes or takes the form another plurality of strands 42 bundled together (e.g., a second stranded cable or wire) to be jointed to the first member 38.

Optionally, in one or more examples, prior to the step of assembling 210, the method 200 include a step of zincating 205 the first member 38. The step of zincating 205 may be achieved by any suitable process for preparing aluminum for plating. For example, a solution of zinc oxide dissolved in sodium hydroxide may be used for the step of zincating 205. The sodium hydroxide may dissolve a surface layer of oxide off the aluminum and zinc is then deposited onto this fresh surface by galvanic action. The thin layer of zinc deposited prevents oxide from reforming and acts as an adherent base onto which other metals, such as copper or brass, can be deposited.

In one or more examples, the step of zincating 205 may also be performed on the second member 40 or any other member of the workpiece 24.

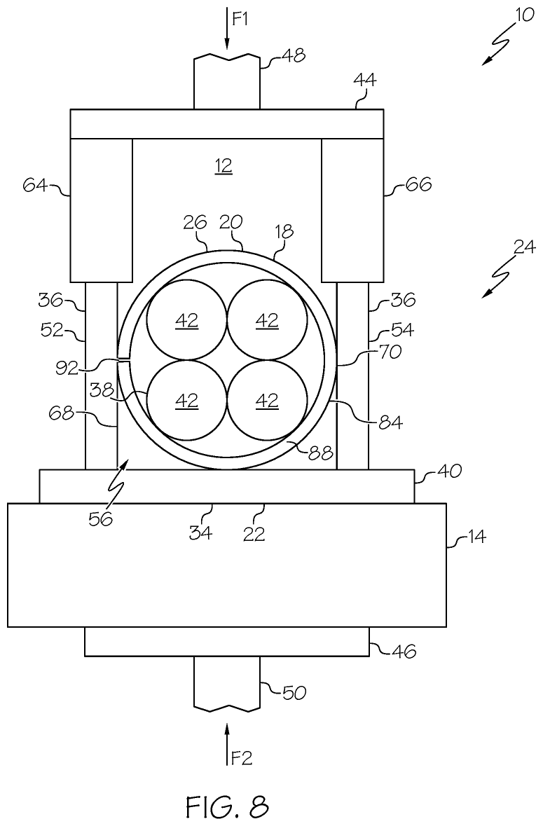

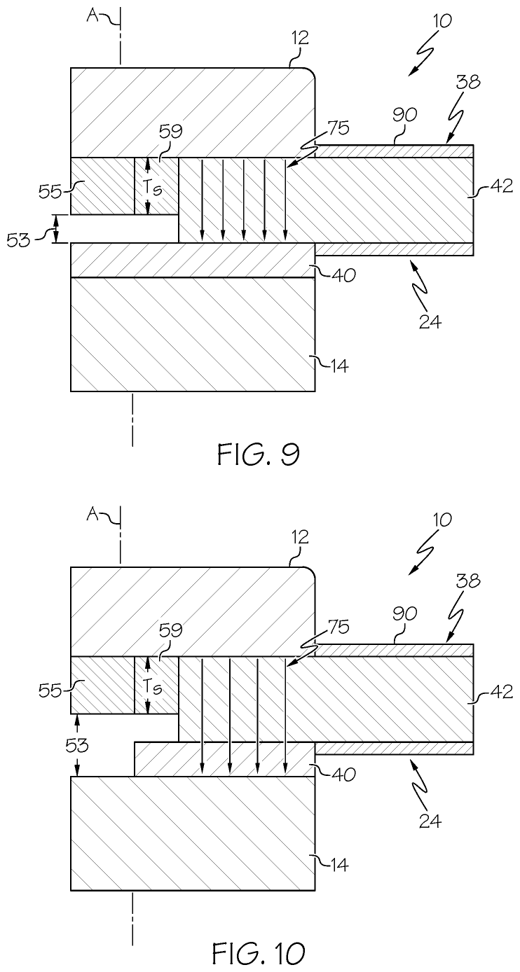

Still referring to FIG. 1, in one or more examples, the method 200 further includes a step of positioning 220 a first electrode 12 in a first position that is proximate (e.g., at or near) the first member 38 such that the first electrode 12 is positioned to be in electrical engagement (e.g., electrically coupled) with the first member 38. The first electrode 12 is moveable between at least a first position and a second position. In one or more examples, the first electrode 12 may further be moveable to a plurality of positions (e.g., between the first position and the second position). In an example, the step of positioning 220 includes positioning the first electrode 12 in abutment and electrical communication with the first member 38 (e.g., in the first position as shown in FIGS. 9-11, 15, 17 and 21).

In one or more examples, in one or more examples, the method 200 includes a step of positioning 230 a second electrode 14 in a first position that is proximate the second member 40 such that the second electrode 14 is positioned to be in electrical engagement (e.g., electrically coupled) with the second member 40. The second electrode 14 may be moveable between at least a first portion and a second position. In one or more examples, the second electrode 14 may be movable to a plurality of positions (e.g., between the first position and the second position). In one example, the positioning 230 includes positioning the second electrode 14 in abutment and electrical communication with the second member 40 (e.g., in the first position as shown in FIGS. 9-11, 15, 17 and 21).

In one or more examples, the first electrode 12 and second electrode 14 are moveable relative to each other. As an example, at least one of the first electrode 12 and second electrode 14 are movable along a longitudinal axis A (e.g., as shown in FIG. 2).

Still referring to FIG. 1, in one or more examples, the method 200 includes a step of positioning 240 a shunt member 55 (e.g., as shown in FIGS. 9-15 and 17) between the first electrode 12 and the second electrode 14 such that the shunt member 55 defines a gap 53 (e.g., as shown in FIGS. 9-11, 15 and 17) between the shunt member 55 and the second electrode 14 (e.g., when the first electrode 12 and/or the second electrode 14 are in respective first positions).

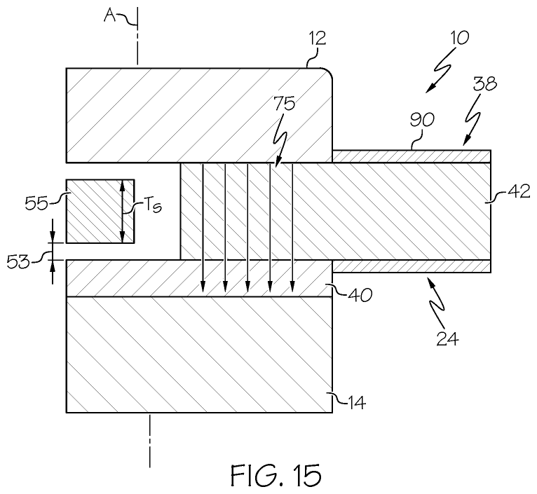

In one or more examples, the shunt member 55 abuts the first electrode 12 when the first electrode 12 is in the first position (e.g., as shown in FIGS. 9-11, 15, 17 and 21). In one or more examples, the shunt member 55 is integral with the first electrode 12, such that the first electrode 12 and the shunt member 55 form a single, monolithic member. In one or more examples, the shunt member 55 is suspended between the first electrode 12 and the second electrode 14 when the first electrode 12 is in the first position (e.g., as shown in FIG. 15).

Referring still to FIG. 1, in one or more examples, the method 200 includes a step of clamping 250 the workpiece 24 between the first electrode 12 and the second electrode 14. The step of clamping 250 may be achieved by placing the welding assembly 10 between a first support structure 44 connected to a first drive element 48 and a second support structure 46 connected to a second drive element 50 (e.g., as shown in FIGS. 3-8 and 16).

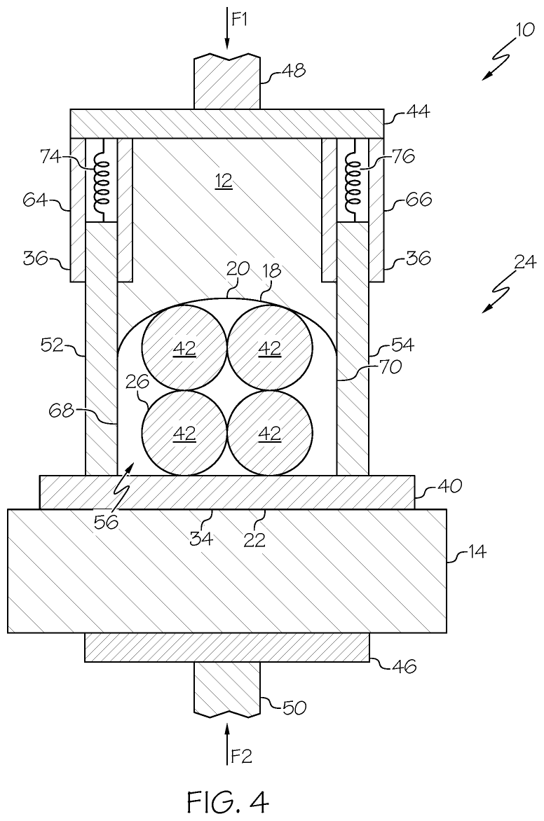

The first drive element 48 and/or the second drive element 50 may be any mechanism suitable to move (e.g., axially translate) the first support structure 44 and/or the second support structure 46 to approximate the first electrode 12 and the second electrode 14 and exert a clamping force (e.g., force F1 and/or force F2 shown in FIGS. 4-8 and 16) to the workpiece 24. For example, the first drive element 48 and/or the second drive element 50 may be a hydraulic, pneumatic, servo-drive or mechanical drive mechanism (e.g., press).

Still referring to FIG. 1, in one or more examples, the method 200 includes a step of passing 260 a welding current 75 (e.g., shown in FIGS. 9-11, 15, 17 and 21) between the first electrode 12 and the second electrode 14, and through the workpiece 24, when the first electrode 12 is in the first position. In one or more examples, the step of passing 260 may occur simultaneously with or during the step of clamping 250.

Upon passing 260 the welding current 75, the workpiece 24 is heated such that it consolidates and conforms to a shape defined by the welding assembly 10. The heating and consolidation combined with the clamping 250 and passing 260 results in the first electrode 12 moving from the first position (e.g., as shown in FIGS. 9-11, 15, 17 and 21) to the second position (e.g., as shown in FIGS. 12-14 and 22), wherein the gap 53 is closed when the first electrode 12 is in the second position. Further, when the first electrode 12 moves to the second position, at least a portion of the welding current 75 is diverted to or passes through the shunt member 55. The shunt member 55 is moved into electrical engagement or coupled with the second electrode 14 in the second position, yielding a lower resistance path for the welding current 75 to pass from the first electrode 12 to the second electrode 14 compared to the workpiece 24. Diverting or passing most of or substantially all the welding current 75 reduces the risk of overeating the workpiece 24 during welding.

In one or more examples, while the welding current 75 is passing 260 between the first electrode 12 and the second electrode 14, the first electrode 12 moves relative to the second electrode 14 from at least a first position to a second position, wherein the gap 53 is closed and at least a portion of the welding current 75 passes through the shunt member 55.

The welding current 75 generally follows a path of least resistance. When the first electrode 12 is in the first position, the path of least resistance is between the first electrode 12, the workpiece 24, and the second electrode 14. Upon moving to the second position, the first electrode 12 is in electrical engagement (e.g., electrically coupled) with the second electrode 14 via the shunt member 55, thus yielding a path of lesser resistance for the welding current 75 to flow as compared to the workpiece 24.

In one or more examples, at least 80% of the welding current 75 diverts or passes through the shunt member 55 upon the first electrode 12 moving to the second position. In one or more examples, at least 90% of the welding current 75 diverts or passes through the shunt member 55 upon the first electrode 12 moving to the second position. In one or more examples, at least 95% of the welding current 75 diverts or passes through the shunt member 55 upon the first electrode 12 moving to the second position. In one or more examples, at least 98% of the welding current 75 diverts or passes through the shunt member 55 upon the first electrode 12 moving to the second position.

In one or more examples, the method 200 includes a step of positioning 245 an electrically nonconductive member 59 between the shunt member 55 and the workpiece 24. The electrically nonconductive member 59 electrically isolates the first member 38 from the shunt member 55 during welding (e.g., when passing 260 the welding current between the first electrode 12 and the second electrode 14).

In one or more examples, the method 200 includes a step of positioning 270 a second electrically nonconductive member 94 between the first member 38 of the workpiece 24 and the second electrode 14. The second electrically nonconductive members 94 electrically isolates the first member 38 from the second electrode 14 during welding (e.g., when passing 260 the welding current between the first electrode 12 and the second electrode 14).

The electrically nonconductive member 59 and/or the second electrically nonconductive member 94 include an electrically nonconductive material and/or may be essentially nonconductive. In one or more examples, the electrically nonconductive member 59 and/or the second electrically nonconductive member 94 include or are made of a ceramic material, a polymeric material, air, or any other material that is highly resistant to electrical current. In one or more examples, the electrically nonconductive member 59 and/or the second electrically nonconductive member 94 include or are made of silicon nitride.

In one or more examples, the method 200 includes a step of providing 255 electrical current to the first electrode 12 and the second electrode 14, such as from a current generator 16 (e.g., as shown in FIG. 2). As an example, the first electrode 12 and the second electrode 14 are electrically coupled with the current generator 16.

The current generator 16 (e.g., as shown in FIG. 2) may be any source of electrical energy capable of supplying electric current to the first electrode 12 and the second electrode 14 to achieve resistive heating in the workpiece 24. The current generator 16 may include appropriate circuitry for supplying electric current to the first electrode 12 and the second electrode 14, as well as controlling the magnitude and timing of the electric current being supplied to the first electrode 12 and the second electrode 14. For example, the current generator 16 may be a direct current system, an alternating current system, or a stored energy current system.

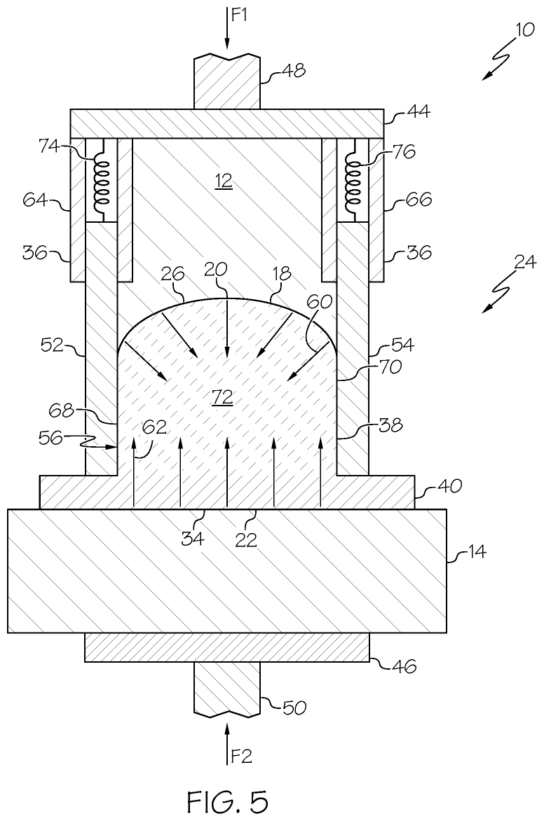

Referring still to FIG. 1, in one or more examples, the method 200 includes a step of positioning 235 the workpiece 24 within a welding volume 56 (e.g., as shown in FIGS. 4 and 5) of a width-determining fixture 36 (e.g., as shown in FIGS. 3-5) to provide width containment of hot/molten metal without inhibiting relative axial movement of the first electrode 12 and/or second electrode 14. In one or more examples, the step of positioning 235 the workpiece 24 within the welding volume 56 (e.g., as shown in FIGS. 4 and 5) of the width-determining fixture 36 is achieved during the step of positioning 220 the first electrode 12 in the first position relative to the first member 38 of the workpiece 24 and the step of positioning 230 the second electrode 14 in the first position relative to the second member 40 of the workpiece 24.

Generally, the welding volume 56 has a width. In one or more examples, at least a portion of the second member 40 of the workpiece 24 extends outside of the width of the welding volume 56 (e.g., as shown in FIGS. 4 and 5). The width-determining fixture 36 may at least partially enclose the workpiece 24 to prevent the flow (e.g., outward flow) of hot or molten metal 72 (e.g., as shown FIG. 5) during resistance welding of the workpiece 24. As an example, width-determining fixture 36 contains at least a portion of the molten metal 72 and prevents the molten metal 72 from flowing radially outward from the weld joint being formed.

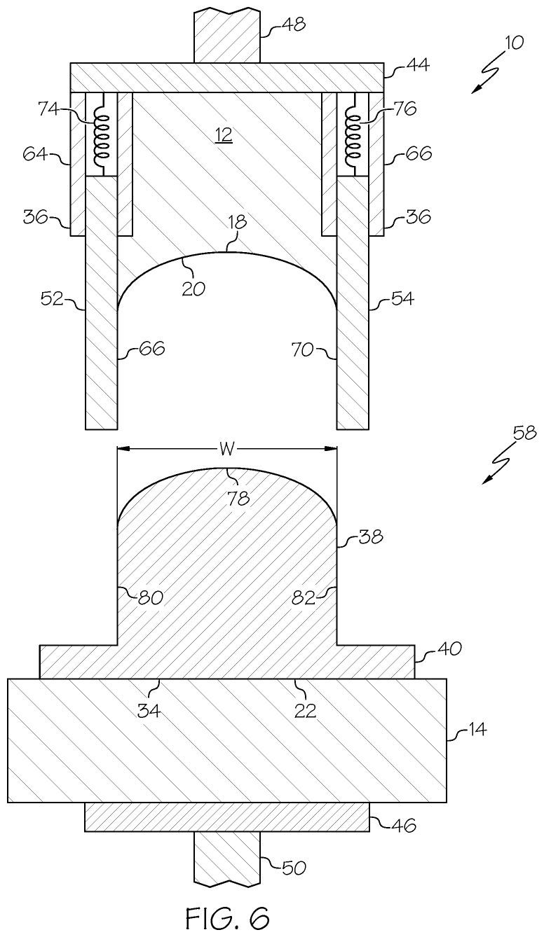

In one or more examples, the width-determining fixture 36 may be capable of adjusting an axial position (e.g., parallel to the direction of the clamping force) with respect to the first electrode 12 and/or the second electrode 14 to ensure sides of the welding volume 56 between the first electrode 12 and the second electrode 14 are completely enclosed to contain the flow of hot or molten metal 72. The position of the width-determining fixture 36 with respect to the workpiece 24 may define the width W of the welded workpiece 58 (e.g., as shown in FIG. 6). Side stops 52, 54 of the width-determining fixture 36 may also be moved out sideways when not welding and moved in when welding, instead of being moved up and down. Such in-and-out movements may also occur through tapered fitting tooling.

Referring still to FIG. 1, in one or more examples, the method 200 includes a step of containing 280 a portion of molten metal between a first interior surface 68 of a first side-stop 52 of the width-determining fixture 36 and a second interior surface 70 of a second side-stop 54 of the width-determining fixture 36, while passing 260 the welding current 75 between the first electrode 12 and the second electrode 14. The method 200 also includes a step of directing 285 a portion of the molten metal 72 toward the first member 38 of the workpiece 24 using a first guide surface 96 of the first side-stop 52 and a second guide surface 98 of the second side-stop 54, while passing 260 the welding current 75 between the first electrode 12 and the second electrode 14.

The step of directing 285 facilitates controlled movement of a portion of the molten metal 72, guided by the first guide surface 96 and the second guide surface 98, which is pushed or squeezed out from the welding volume 56 during the steps of clamping 250 and the passing 260. The portion of the molten metal 72, which is pushed out from the welding volume 56 and directed by the first guide surface 96 and the second guide surface 98, settles on a portion (e.g., sides) of the first member 38 (e.g., a bare portion of the bundle of metal strands 42). Upon cooling and hardening, a portion of the welded joint extends over an unwelded portion of the first member 38 to provide additional metallurgical and mechanical strength to sides of the first member 38 (e.g., stranded cable) and provides some strain relief to the weld joint. This also helps prevent the strands 42 (e.g., wires) from bending sideways outwardly and breaking while in service.

Referring still to FIG. 1, optionally, in one or more examples, the method 200 may include a step of cooling 265. The step of cooling 265 may be performed between the various steps of the method 200 or may be combined with the various steps of the method 200, such as combined with the step of passing 260 of the welding current 75. For example, the workpiece 24 may be cooled (e.g., during or after welding) by circulating cooling fluid through fluid channels in the first electrode 12 and/or the second electrode 14 while one or both of the first electrode 12 and the second electrode 14 are engaged with the workpiece 24. In one example, the method 200 includes the step of cooling 265 at least one of the first electrode 12 and the second electrode 14 during the step of passing 260 the welding current 75 between the first electrode 12 and the second electrode 14.

Referring now to FIG. 2, disclosed is an example of the welding assembly 10. The welding assembly 10 may be implemented with the method 200 described herein. In one or more examples, the welding assembly 10 includes the first electrode 12 and the second electrode 14. The first electrode 12 and the second electrode 14 may be located at axially opposite positions relative to the longitudinal axis A of the welding assembly 10. The workpiece 24 may be positioned between the first electrode 12 and the second electrode 14.

The first electrode 12 and the second electrode 14 may be moveable between a plurality of positions relative to each other along the longitudinal axis A. In one example, the first electrode 12 and the second electrode 14 are moveable relative to each other along the longitudinal axis A between at least the first position (e.g., as shown in FIGS. 9-11, 15, 17 and 21) and the second position (e.g., as shown in FIGS. 12-14 and 22).

In one or more examples, the first electrode 12 moves from the first position to the second position while or upon passing the welding current 75 between the first electrode 12 and the second electrode 14. The passing of the welding current 75 results in a localized heat effected zone that melts or consolidates the workpiece 24. Upon consolidation of the workpiece 24, the first electrode 12 and/or the second electrode 14 may move to the second position to apply the clamping force to the workpiece 24.

In one or more examples, while the welding current 75 is passing between the first electrode 12 and the second electrode 14 through the workpiece 24, the first electrode 12 moves relative to the second electrode 14 from at least the first position to the second position, such that the gap 53 is closed and at least a portion of the welding current 75 passes directly between the first electrode 12 and the second electrode 14 through the shunt member 55.

Referring now to FIGS. 2-6, in one or more examples, the first electrode 12 is electrically coupled to the current generator 16 and includes a first engagement surface 18. The second electrode 14 is electrically coupled to the current generator 16 and includes a second engagement surface 22. The first engagement surface 18 and the second engagement surface 22 may include a size and shape suitable to engage (e.g., contact) at least a portion of an exterior surface 26 of the workpiece 24 (e.g., as shown in FIGS. 3 and 4). For example, the first engagement surface 18 of the first electrode 12 and the second engagement surface 22 of the second electrode 14 may be configured to solidify a plurality of metal or metal alloy strands, such as a metal or metal alloy stranded cable or wire (e.g., first member 38) and weld the solidified strands to a metal or metal alloy connector terminal (e.g., second member 40).

The current generator 16 may be any source of electrical energy capable of supplying an electric current to the first electrode 12 and the second electrode 14 to achieve resistive heating in the workpiece 24 (e.g., as shown in FIGS. 3-5). The current generator 16 may include appropriate circuitry for supplying electric current to the first electrode 12 and the second electrode 14, as well as controlling the magnitude and timing of the electric current being supplied to the first electrode 12 and the second electrode 14. For example, the current generator 16 may be a direct current system, an alternating current system, or a stored energy current system.

As shown in FIG. 2, in one or more examples, the current generator 16 may include a first terminal 112 and a second terminal 114, the second terminal 114 having a polarity opposite of a polarity of the first terminal 112. The first electrode 12 may be electrically coupled to the first terminal 112. The second electrode 14 may be electrically coupled to the second terminal 114. Those skilled in the art will appreciate that the current generator 16 may be a commercially available resistance welding machine or a component taken from a commercially available resistance welding machine.

The first electrode 12 and the second electrode 14 may be formed from any electrically conductive material. The first electrode 12 and the second electrode 14 may be formed from a material having a thermal conductivity (e.g., either relatively high thermal conductivity or relatively low thermal conductivity) selected based upon the type of weld desired, the material (e.g., aluminum or aluminum alloy) of the workpiece 24, and/or the method for welding being performed by the first electrode 12 and the second electrode 14.

In one or more examples, the first electrode 12 and/or the second electrode 14 may be formed from copper or copper alloys (e.g., Resistance Welder Manufacturers Association (“RWMA”) copper alloys Classes 1-5 or 20) when relatively high thermal conductivity is desired. Alternatively, the first electrode 12 and/or the second electrode 14 may be formed from refractory materials, tungsten, tungsten/copper alloys or molybdenum (e.g., RWMA Classes 10-14) when relatively low thermal conductivity is desired. In general, a more conducting electrode material may be used when a steeper thermal gradient is desired between the first electrode 12 and the second electrode 14 and a less conducting electrode material may be used when a less steep temperature gradient is desired between the first electrode 12 and the second electrode 14.

Referring still to FIG. 2, the first electrode 12 and/or the second electrode 14 may be cooled. For example, the first electrode 12 may include one or more first fluid channels 30 defined therein or connected thereto. The second electrode 14 may include one or more second fluid channels 32 defined therein or connected thereto. A cooling fluid (e.g., water or ethyl glycol) may flow through the first fluid channels 30 and/or the second fluid channels 32 to remove heat from the first electrode 12 and the second electrode 14, as well as from the workpiece 24 (e.g., as shown in FIG. 4), the molten metal 72 (e.g., shown in FIG. 5), and/or the welded workpiece 58 (e.g., as shown in FIG. 6), supported by (e.g., positioned between) the first electrode 12 and the second electrode 14.

Referring to FIG. 3, in one or more examples, the first electrode 12 may be mounted to the first support structure 44 and the second electrode 14 may be mounted to the second support structure 46. For example, the first support structure 44 and/or the second support structure 46 may be an arm or a tong. The first support structure 44 and the second support structure 46 may be capable of approximating the first electrode 12 and the second electrode 14 to clamp the workpiece 24 between the first electrode 12 and the second electrode 14.

In one example, the first electrode 12 and the second electrode 14 may exert a clamping force (e.g., a welding force) to the workpiece 24 positioned there between. For example, the first electrode 12 and the second electrode 14 may exert a clamping force of approximately between 50 pounds and 100 pounds. In one example, the first support structure 44 may be moveable such that the first electrode 12 exerts a welding force F1 to the workpiece 24 and the second support structure 46 may be moveable such that the second electrode 14 exerts an opposing welding force F2 to the workpiece 24 (e.g., as shown in FIGS. 4, 5, 7, 8 and 16). As another example, the first support structure 44 may be a moveable such that the first electrode 12 exerts a welding force F1 to the workpiece 24 and the second support structure 46 may be stationary (e.g., an anvil).

Referring still to FIG. 3, the first support structure 44 may be connected to the first drive element 48 and/or the second support structure 46 may be connected to the second drive element 50. The first drive element 48 and/or the second drive element 50 may be any mechanism suitable to move (e.g., axially translate) the first support structure 44 and/or the second support structure 46 to approximate the first electrode 12 and the second electrode 14 and exert the clamping force to the workpiece 24. For example, the first drive element 48 and/or the second drive element 50 may be a hydraulic, pneumatic, servo-drive or mechanical drive mechanism (e.g., press).

Referring now to FIGS. 9-15 and 17, the welding assembly 10 includes the shunt member 55. The shunt member 55 is located between the first electrode 12 and the second electrode 14. In one or more examples, the shunt member 55 is coupled to the first electrode 12. In one or more examples, the shunt member 55 is integral with the first electrode 12 such that it is a single, monolithic member. In one or more examples, the shunt member 55 may be removably coupled with the first electrode 12 or otherwise abuts the first electrode 12. In one or more examples, the shunt member 55 suspended or otherwise selectively positioned between the first electrode 12 and the second electrode 14 when the first electrode 12 is in the first position.

The shunt member 55 is configured to be electrically isolated from the second electrode 14 when the first electrode 12 is in the first position (e.g., as shown in FIGS. 9-11, 15, 17 and 21). As an example, with the first electrode 12 in the first position, the shunt member 55 is spaced away from and, thus, is not in electrical communication with, the second electrode 14 by the gap 53. The shunt member 55 is electrically coupled with both the first electrode 12 and the second electode 14 when the first electrode 12 is in the second position (e.g., as shown in FIGS. 12-14 and 22).

When the first electrode 12 is in the first position, the shunt member 55 defines the gap 53 between the shunt member 55 and the second electrode 14. The shunt member 55 has an axial thickness T_{S} (e.g., as shown in FIGS. 9-15 and 17), for example, along the longitudinal axis A.

In one example, the axial thickness T_{S} of the shunt member 55 is a function of the first member 38. For example, the first member 38 may be comprised of a plurality of strands 42 that are arranged within the welding assembly 10 (e.g., as shown in FIG. 3). The plurality of strands 42 have a volume of airspace defined by the stacked configuration and space between each strand. After consolidation of the plurality of strands 42 upon passing the welding current 75, the plurality of strands become molten metal 72 (e.g., as shown in FIG. 5) and the airspace is removed. In other words, during welding (e.g., passing the welding current 75), the molten metal 72 fills the welding volume 56 formed by the welding assembly 10 (e.g., by the width-determining fixture 36). Therefore, the axial thickness T_{S} of the shunt member 55 may be approximately the same as the axial thickness T_{M} (e.g., as shown in FIGS. 12-14) of the molten metal 72 during resistive heating and the welded workpiece 58 (e.g., as shown in FIG. 6) after consolidation to yield electrical engagement between the shunt member 55, the first electrode 12, and the second electrode 14.

When the first electrode 12 is in the second position, the shunt member 55 is in electrical engagement with the first electrode 12 and the second electrode 14. This electrical engagement yields a less resistive path for the welding current 75 to travel, thus diverting a portion, or substantially all, of the welding current 75 from travelling through the workpiece 24 to travelling through the shunt member 55.

In one or more examples, at least 80% of the welding current 75 diverts or passes through the shunt member 55 upon the first electrode 12 moving to the second position. In one or more examples, at least 90% of the welding current 75 diverts or passes through the shunt member 55 upon the first electrode 12 moving to the second position. In one or more examples, at least 95% of the welding current 75 diverts or passes through the shunt member 55 upon the first electrode 12 moving to the second position. In one or more examples, at least 98% of the welding current 75 diverts or passes through the shunt member 55 upon the first electrode 12 moving to the second position.

Still referring to FIGS. 9-15 and 17, in one or more examples, the welding assembly 10 includes the electrically nonconductive member 59. The electrically nonconductive member 59 may be located between the shunt member 55 and at least a portion of the workpiece 24, such as between the shunt member 55 and the first member 38 (e.g., an end of the first member 38 as shown in FIGS. 9-14 and 17).

In one or more examples, the electrically nonconductive member 59 includes a ceramic material. As an example, the electrically nonconductive member 59 includes silicon nitride. As another example, the electrically nonconductive member 59 includes air. Any suitable material for stopping the flow of welding current 75 and/or electrically isolating the shunt member 55 from at least a portion of the workpiece 24 may be implemented for the electrically nonconductive member 59.

A size, shape, and/or volume of the electrically nonconductive member 59 may be a function of the airspace defined by the plurality of strands 42 of the first member 38. For example, the electrically nonconductive member 59 may be sized such that upon consolidation of the plurality of strands 42, the electrically nonconductive member 59 allows for electrical engagement between shunt member 55 and the first electrode 12 and second electrode 14.

As illustrated in FIGS. 9 and 12, in one or more examples, the electrically nonconductive member 59 electrically isolates the shunt member 55 from the first member 38 with the welding assembly in the first position (e.g., as shown in FIG. 9) and in the second position (e.g., as shown in FIG. 12). The electrically nonconductive member 59 enables electrical communication of the shunt member 55 with the second member 40 with the welding assembly in the second position (e.g., as shown in FIG. 12).

As illustrated in FIGS. 9 and 12, in one or more examples, the electrically nonconductive member 59 electrically isolates the shunt member 55 from the first member 38 with the welding assembly in the first position (e.g., as shown in FIG. 9) and in the second position (e.g., as shown in FIG. 12). The electrically nonconductive member 59 enables electrical communication of the shunt member 55 with the second member 40 with the welding assembly in the second position (e.g., as shown in FIG. 12).

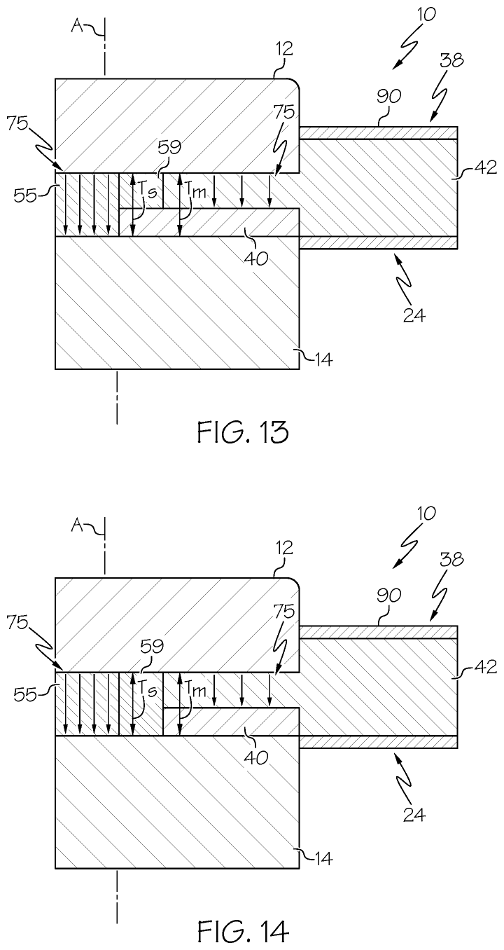

As illustrated in FIGS. 10 and 13, in one or more examples, the electrically nonconductive member 59 electrically isolates the shunt member 55 from the first member 38 with the welding assembly in the first position (e.g., as shown in FIG. 9) and in the second position (e.g., as shown in FIG. 12). The electrically nonconductive member 59 electrical isolates a portion of the shunt member 55 from the second member 40 with the welding assembly in the second position (e.g., as shown in FIG. 12).

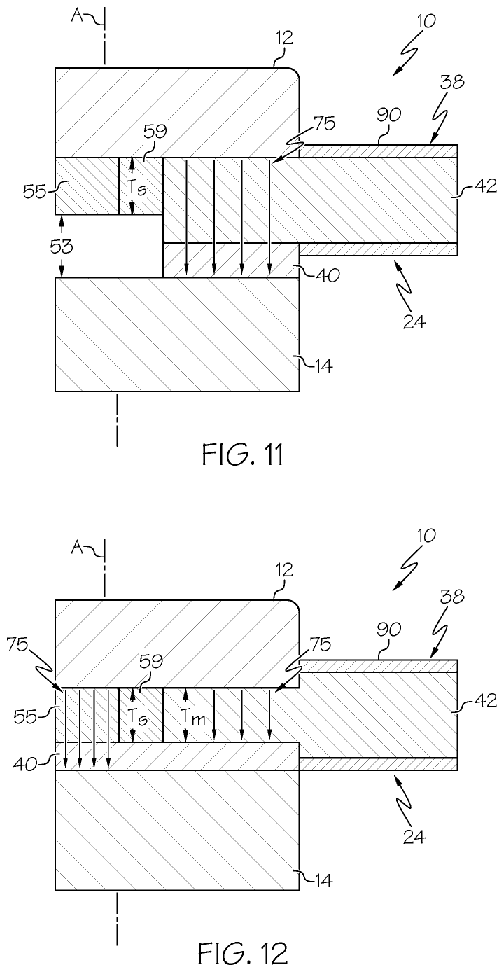

As illustrated in FIGS. 11 and 14, in one or more examples, the electrically nonconductive member 59 electrically isolates the shunt member 55 from the first member 38 with the welding assembly in the first position (e.g., as shown in FIG. 9) and in the second position (e.g., as shown in FIG. 12). The electrically nonconductive member 59 electrical isolates the shunt member 55 from the second member 40 with the welding assembly in the second position (e.g., as shown in FIG. 14).

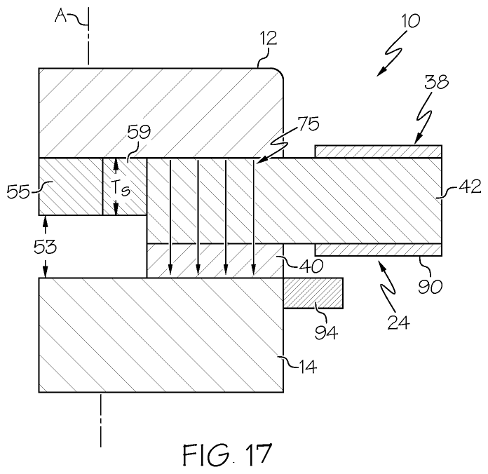

Referring now to FIG. 17, in one or more examples, the welding assembly 10 also includes the second electrically nonconductive member 94. The second electrically nonconductive member 94 is located or otherwise positioned between the first member 38 of the workpiece 24 and the second electrode 14. The second electrically nonconductive member 94 electrically isolates the first member 38 from the second electrode 14 when passing the welding current 75 between the first electrode 12 and the second electrode 14 and through the workpiece 24.

As illustrated in FIG. 17, generally, the sheathing 90 of the first member 38 (e.g., surrounding the bundle of strands 42) is removed from a portion of the bundle of strands 42 prior to welding the first member 38 and the second member 40 (or applying the auxiliary member 84). In certain instances, a remaining portion of the sheathing 90 is spaced away from welding assembly 10 such that a portion of bare metal material (e.g., bare strands 42) extends from between the first electrode 12 and the second electrode 14 and is exposed to electrical communication with the second electrode 14 during welding, such as during application of the clamping or welding force (e.g., forces F1 and/or F2) when the welding assembly 10 is moved from the first position to the second position.

The second electrically nonconductive member 94 prevents the bare metal portion of the first member 38 from contacting the second electrode 14 during welding. Electrically isolating the first member 38 from the second electrode 14 ensures that the welding current 75 is directed between the first electrode 12 and the second electrode 14, through the first member 38 and the second member 40 (e.g., as shown in FIG. 17), rather than through only the first member 38.

The second electrically nonconductive member 94 includes an electrically nonconductive material and/or may be essentially nonconductive. In one or more examples, the second electrically nonconductive member 94 includes or is made of a ceramic material, a polymeric material, air, or any other material that is highly resistant to electrical current. In one or more examples, the second electrically nonconductive member 94 includes or is made of silicon nitride.

Referring to FIGS. 3-6, in one or more examples, the width-determining fixture 36 may be positioned between the first electrode 12 and the second electrode 14 to define the welding volume 56 (e.g., as shown in FIGS. 4 and 5) around at least a portion of the workpiece 24. The width-determining fixture 36 may at least partially enclose the workpiece 24 to contain and prevent the flow (e.g., radially outward flow) of the molten metal 72 (e.g., as shown in FIG. 5) during resistance welding of the workpiece 24. The width-determining fixture 36 may be capable of adjusting an axial position (e.g., parallel to the direction of the clamping force) with respect to the first electrode 12 and/or the second electrode 14 to ensure sides of the welding volume 56 between the first electrode 12 and the second electrode 14 are completely enclosed. The position of the width-determining fixture 36 with respect to the workpiece 24 may define the width W of the welded workpiece 58 (e.g., as shown in FIG. 6). The side-stops 52, 54 of the width-determining fixture 36 may also be moved out sideways when not welding and moved in when welding, instead of being moved up and down. Such in-and-out movements may also occur through tapered fitting tooling.

Referring to FIG. 4, in one or more examples, the width-determining fixture 36 may be connected to or otherwise operably engaged with the first support structure 44 and/or the first drive element 48 to approximate the second electrode 14 in response to the welding force F1 (e.g., as shown in FIG. 4). While not explicitly illustrated, in another example, the width-determining fixture 36 may be connected to or otherwise operably engaged with the second support structure 46 and/or the second drive element 50 to approximate the first electrode 12 in response to the welding force F2.

Referring still to FIGS. 3 and 4, the workpiece 24 may include one or more of the first member 38 and the second member 40 intended to be joined by resistive welding. While two members, the first member 38 and the second member 40 of the workpiece 24 are shown in FIGS. 3 and 4, those skilled in the art will appreciate that additional members may be included in the workpiece 24 without departing from the scope of the present disclosure.

The first member 38 and the second member 40 of the workpiece 24 may be formed from any material capable of being joined by resistive heating. In one realization, the first member 38 and the second member 40 of the workpiece 24 may be formed from any metals or metal alloys capable of being joined by resistive heating. For example, the first member 38 and the second member 40 of the workpiece 24 may be formed from aluminum or aluminum alloys, brass, copper or copper alloys, tin, zinc, or any combination thereof.

In another example, the first member 38 and the second member 40 of the workpiece 24 may be zincated aluminum. Any process for preparing aluminum for plating may be utilized. For example, a solution of zinc oxide dissolved in sodium hydroxide may be used for the zincating. The sodium hydroxide may dissolve the surface layer of oxide off the aluminum and zinc is then deposited onto this fresh surface by galvanic action. The thin layer of zinc deposited prevents oxide from reforming and acts as an adherent base onto which other metals, such as copper or brass, can be deposited.

Referring to FIG. 3, the first member 38 may include at least two of the plurality of strands 42. Each strand 42 may be formed from metal or metal alloy (e.g., aluminum or aluminum alloy). Optionally, the first member 38 includes copper, brass, tin, zinc, aluminum, or any combination thereof. For example, the first member 38 may be formed from a plurality of strands 42 that are elongated and bundled together and having a generally circular cross-sectional shape. As a general, non-limiting example, the first member 38 may be a metal wire, cable or rope. As a specific, non-limiting example, the first member 38 may be a 25 mm², 40 mm² or 50 mm² stranded wire cable.

The second member 40 may be a terminal to which the first member 38 (e.g., a stranded cable or wire) is joined by welding. For example, the second member 40 may be a connector terminal suitable for connection (e.g., mechanical and/or electrical connection) to another object (e.g., an aircraft frame, a vehicle frame, or an electrical junction).

Referring to FIGS. 2-6, in one or more examples, the first engagement surface 18 of the first electrode 12 may be formed into an arcuate (e.g., curved) surface defining a concave recess 20 configured to make flush contact with at least a portion of the exterior surface 26 of the first member 38. For example, the first engagement surface 18 may be machined as a generally semicircular shape or an inverted U shape defining a generally semicircular recess 20 configured to make flush contact with at least a portion of the exterior surface 26 (e.g., a semi-circular portion of the circumferential exterior surface) of the first member 38 (e.g., a stranded cable or wire).

In one or more examples, the second engagement surface 22 may be formed into a substantially planar surface configured to make flush contact with at least a portion of the exterior surface 34 of the second member 40. For example, the second engagement surface 22 may be machined as a substantially flat shape configured to make flush contact with a substantially planar portion of the exterior surface 34 (e.g., a portion of a bottom surface) of the second member 40 (e.g., a connector terminal).

As illustrated in FIG. 5, in one or more examples, the curved first engagement surface 18 of the first electrode 12 may create a larger contact surface area for electrical current (e.g., welding current 75) to pass from the first electrode 12 to the first member 38 (e.g., to the plurality of strands 42) as compared to a planar engagement surface. This larger surface area may decrease the current density at a surface of the workpiece 24 (e.g., between the curved engagement surfaces 18 and 26 of the first electrode 12 and the first member 38) and increase the current density proximate a center of the workpiece 24. For example, the curved first engagement surface 18 may direct (e.g., focus) the current from the first electrode 12 toward the center of the first member 38, as illustrated by directional arrows 60.

The current density at an opposing surface of the workpiece 24 (e.g., between planar engagement surfaces 22 and 34 of the second electrode 14 and the second member 40) may be higher or lower. For example, the planar second engagement surface 22 may direct the current from the second electrode 14 through the second member 40 and through the first member 38, as illustrated by directional arrows 62.

Thus, when a voltage is applied between the first electrode 12 and the second electrode 14 (e.g., from the current generator 16), the welding current 75 (e.g., as shown in FIGS. 9-15 and 17) flows between the first engagement surface 18 and the second engagement surface 22 through the core of the workpiece 24 along the path indicated by arrows 60 and 62. By decreasing the welding current 75 density at the exterior surface 26 of the first member 38 (e.g., at the exterior surfaces of the strands 42) and increasing the welding current 75 density toward the center of the first member 38, the heat generated proximate (e.g., at or near) the center of the first member 38 (the heat effected zone) may become greater than the heat generated at any location on the exterior surface 26 of the first member 38 tending to more consistently melt the plurality of strands 42 throughout the first member 38.

Those skilled in the art will appreciate that the first engagement surface 18 and the recess 20 may be provided in various sizes (e.g., length and width), shapes (e.g., curve radius) and configurations, for example, depending upon the diameter of the first member 38, the number of strands 42 and the length of the first member 38 (e.g., length of a portion of the plurality of strands 42) that is to be welded (e.g., solidified).

Referring still to FIGS. 2-6, the width-determining fixture 36 may be positioned adjacent to the first electrode 12. In one construction, the width-determining fixture 36 may include a first (e.g., left) side-stop 52 and a second (e.g., right) side-stop 54. The first side-stop 52 may be positioned adjacent to (e.g., to the left of) the first electrode 12 and the second side-stop 54 may be positioned adjacent to (e.g., to the right of) the first electrode 12 such that the first side-stop 52 and the second side-stop 54 are positioned to the sides (e.g., the left side and the right side) of the first member 38 when the clamping force is exerted to the workpiece 24.

The first side-stop 52 and the second side-stop 54 may formed from a material having an electrical resistance greater than that of the first electrode 12 and the second electrode 14. For example, the first side-stop 52 and the second side-stop 54 may be formed from a high resistance metal. As another example, the first side-stop 52 and the second side-stop 54 may be formed from an electrically insulating or non-conductive material, such as ceramic. In general, the material of the first side-stop 52 and the second side-stop 54 may be selected to ensure the electrical current (e.g., welding current 75) is directed through the workpiece 24, such as indicated by directional arrows 60 and 62 (e.g., as shown in FIG. 5).

In one or more examples, the first side-stop 52 may be housed within a first sleeve 64 and the second side-stop 54 may be housed within a second sleeve 66. The first sleeve 64 and the second sleeve 66 may be connected to the first support structure 44 such that the first side-stop 52 and the second side-stop 54 define the welding volume 56 around (e.g., to the sides of) the first member 38 as the first electrode 12 approximates the second electrode 14 in response to the welding force F1 (e.g., as shown in FIG. 4). When the first electrode 12 approaches the second electrode 14 and exerts the clamping force to the first member 38 therebetween, the first side-stop 52 and the second side-stop 54 may engage the second member 40 (e.g., connector terminal) adjacent to the first member 38 (e.g., stranded cable). As such, the welding volume 56 may be defined by the first engagement surface 22 of the first electrode 12, an interior surface 68 of the first side-stop 52, an interior surface 70 of the second side-stop 54 and a portion of the exterior surface 34 (e.g., a top surface) of the second member 40 positioned between the first side-stop 52 and the second side-stop 54.

The position of the first side-stop 52 and the second side-stop 54 with respect to the first sleeve 64 and the second sleeve 66, respectively, may automatically adjust an axial position (e.g., parallel to the direction of the welding force F1) to constantly engage the exterior surface 34 of the second member 40 and contain the flow of molten metal 72 within the welding volume 56 (e.g., as shown in FIG. 5). The first side-stop 52 may be outwardly biased from within the first sleeve 64 and the second side-stop 54 may be outwardly biased from within the second sleeve 66. For example, the first side-stop 52 may be connected within the first sleeve 64 by a first biasing element 74 (e.g., a spring) and the second side-stop 54 may be connected within the second sleeve 66 by a second biasing element 76 (e.g., a spring). A bottom surface of the first side-stop 52 and the second side-stop 54 may be substantially planar to make flush contact with the substantially planar exterior surface 34 of the second member 40 or with a substantially planar surface of the second electrode 14.

As the first support structure 44 approximates the second support structure 46 (e.g., via the first drive element 48), the first electrode 12 may move toward and exert the welding force F1 (e.g., clamping force) upon the first member 38 and the first side-stop 52 and the second side-stop 54 may simultaneously move toward and engage the second member 40. As the first support structure 44 further approximates the second support structure 46, the welding force F1 exerted to the first member 38 by the first electrode 12 and the second electrode 14 may increase as the first electrode 12 approximates the second electrode 14; however, the first side-stop 52 and the second side-stop 54 may be at least partially pushed into the first sleeve 64 and the second sleeve 66, respectively, to prevent damage to the second member 40 while maintaining flush contact with the second member 40 and containing the radially outward flow of the molten metal 72 (e.g., as shown in FIG. 5).

Referring now to FIG. 6, the welded workpiece 58 may have a shape substantially matching the shape of the welding volume 56. For example, welded workpiece 58 may include a curved upper end 78 substantially matching the curved first engagement surface 18 of the first electrode 12, a planar first (e.g., left) side 80 substantially matching the planar first interior surface 68 of the first side-stop 52 and a planar second (e.g., right) side 82 substantially matching the planar second interior surface 70 of the second side-stop 54. The welded workpiece 58 may include a solidified portion of the plurality of strands 42 of the first member 38 (e.g., a stranded cable) joined to the second member 40 (e.g., a connector terminal) through resistive welding.

Referring to FIGS. 7, 8 and 16, the workpiece 24 may also include an auxiliary member 84. The auxiliary member 84 may have a size and shape sufficient to at least partially surround at least a portion of the workpiece 24. For example, the auxiliary member 84 is configured to surround at least a portion of the first member 38 that is to be welded to the second member 40. The auxiliary member 84 may be formed from a material having the same or similar chemistry as the first member 38 and second member 40, or from a material that is compatible with the material from which the first member 38 and second member 40 are formed. For example, when the members 38, 40 are formed from aluminum alloys, the auxiliary member 84 may be formed from an aluminum alloy or appropriate aluminum alloy filler metal.

As illustrated in FIG. 7, in one example, the auxiliary member 84 includes or takes the form of a band 86. In one or more examples, the band 86 has a generally semi-circular shape having an arcuate (e.g., curved) body (e.g., U-shaped) of sufficient size and shape to at least partially surround (e.g., cover) the exterior surface 26 of the first member 38 (e.g., a stranded cable) and ends that extend to engage the exterior surface 34 of the second member 40 (e.g., a connector terminal). In one or more examples, the auxiliary band 86 has a generally circular shape having a continuous body of sufficient size and shape to completely surround (e.g., cover) the exterior surface 26 of the first member 38 (e.g., a stranded cable).

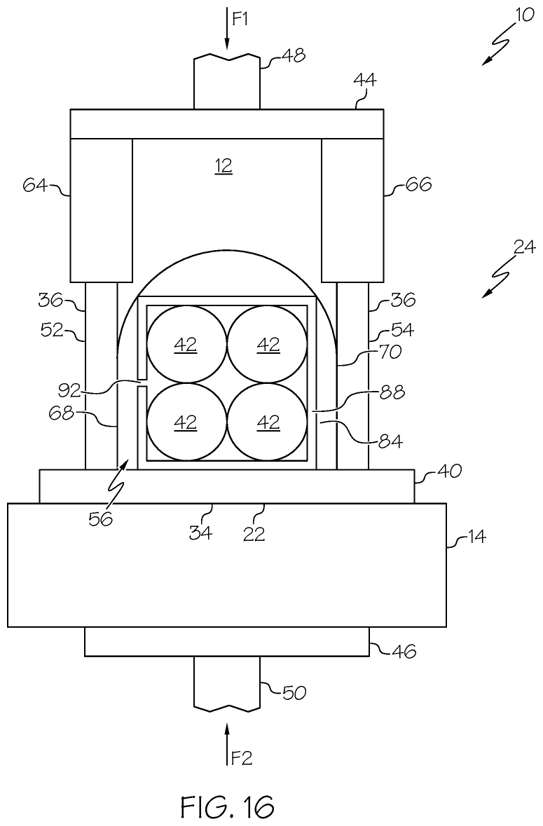

As illustrated in FIGS. 8 and 16, in one or more examples, the auxiliary member 84 includes or takes the form of a tube 88. The tube 88 has a tubular shape with a hollow interior of sufficient size and shape to completely surround (e.g., cover) the exterior surface 26 of the first member 38 (e.g., a stranded cable). As illustrated in FIG. 8, in one or more examples, the tube 88 has a circular cross-sectional shape. As illustrated in FIG. 16, in one or more examples, the tube 88 has a rectangular (e.g., square) cross-sectional shape. In one or more examples, the tube 88 has a continuous body. In one or more examples, the tube 88 has a discontinuous body and/or includes a split 92 (e.g., as shown in FIGS. 8 and 16) that extends a length of the tube 88. The split 92 enables the tube 88 to the pulled apart or expanded for insertion of the first member 38 and closed again.

Regardless of the cross-sectional shape of the auxiliary member 84, the auxiliary member 84 has an internal dimension that closely approximates a cross-sectional dimension (e.g., diameter) of the first member 38 (e.g., the bundle of metal strands 42). In this way, at least a portion of the auxiliary member 84 is in direct contact with at least a portion of the first member 38.

In one or more examples, the curved first engagement surface 18 of the first electrode 12 may include a sufficient shaped and size to contact at least a portion of an exterior surface 26 the auxiliary member 84 and focus electrical current (e.g., welding current 75) toward the center of the workpiece 24 (e.g., the first member 38) in a similar manner as described above and illustrated in FIG. 5.

The material of the auxiliary member 84 may soften or melt during resistance welding and at least partially combine with the molten metal 72 (e.g., as shown in FIG. 5) within the welding volume 56 to further solidify the plurality of strands 42 of the first member 38 into the solid welded workpiece 58 (e.g., as shown in FIG. 6). The first side-stop 52 and the second side-stop 54 may be positioned adjacent to (e.g., to the sides of) the auxiliary member 84 when the first electrode 12 exerts welding force F1 upon the workpiece 24.

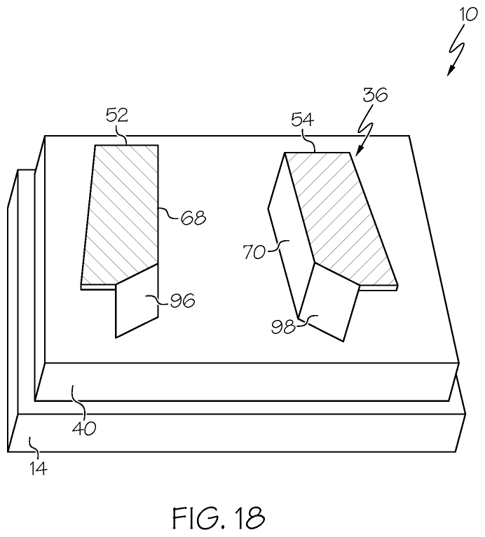

Referring now to FIGS. 18-20, which schematically illustrate examples of the width-determining fixture 36. As described above and also illustrated in FIGS. 3-6, in one or more examples, the width-determining fixture 36 includes the first side-stop 52 and the the second side-stop 54. The second side-stop 54 is spaced apart from and is laterally opposed to the first side-stop 52. The first side-stop 52 and the second side-stop 54 form a portion of the boundary of the welding volume 56. The first side-stop 52 and the second side-stop 54 contain the molten metal 72 (e.g., as shown in FIG. 5) within the width of the welding volume 56 without inhibiting relative movement of the first electrode 12 and the second electrode 14.

In one or more examples, the first side-stop 52 includes the first interior surface 68 and a first guide surface 96. The first guide surface 96 extends from the first interior surface 68 at a first oblique angle. The second side-stop 54 includes the second interior surface 70 and a second guide surface 98. The second guide surface 98 extends from the second interior surface 70 at a second oblique angle. In one or more examples, the first interior surface 68 and the second interior surface 70 are at least approximately parallel to each other and extend along a portion of a length of the first member 38. The first guide surface 96 is angled in an outward direction relative to the first interior surface 68 and the welding volume 56. Similarly, the second guide surface 98 is angled in an outward direction relative to the second interior surface 70 and the welding volume 56.

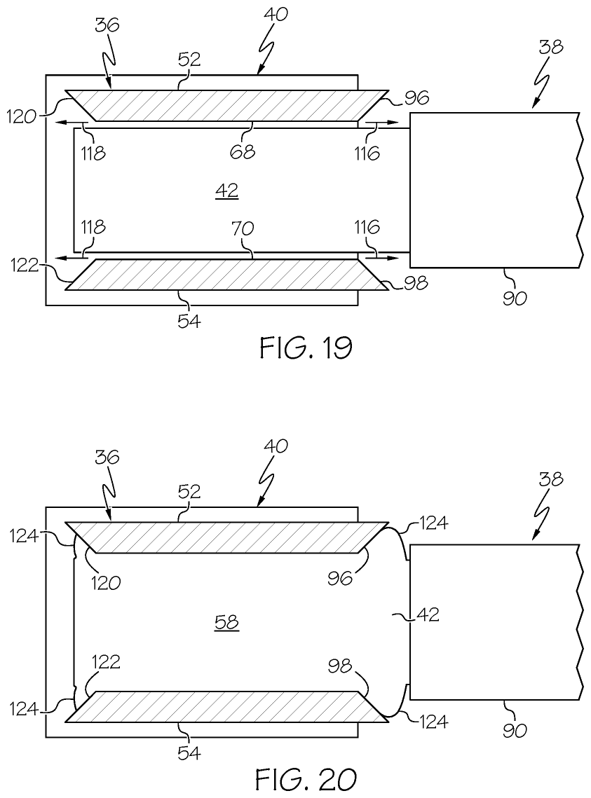

As such, the first guide surface 96 and the second guide surface 98 direct a portion of the molten metal 72 outward from the welding volume 56. As an example, during welding (e.g., when passing the welding current 75 through the workpiece 24 and applying the clamping force (F1 and/or F2) to the workpiece 24, a first (e.g., relatively large) portion of the molten metal 72 is contained between the first interior surface 68 of the first side-stop 52 and the second interior surface 70 of the second side-stop 54 and, thus, fills the welding volume 56 (e.g., as shown in FIG. 5). Concurrently, a second (e.g., relatively small) portion of the molten metal 72 is pushed or squeezed out from the welding volume 56 along the length of the first member 38 (e.g., in the directions of directional arrows 116 and 118 shown in FIG. 19) during clamping.

After consolidation and cooling of the molten metal 72 into the welded workpiece 58 (e.g., as shown in FIG. 20), a portion of the welded joint (the melted and resolidified metal) extends over an unwelded portion of the first member 38 (e.g., the bare strands 42) to provide additional metallurgical and mechanical strength to sides of the first member 38 (e.g., stranded cable) and provides some strain relief to the weld joint. For example, and as illustrated in FIG. 20, the welded workpiece 58 includes one or more beads 124 located on opposing sides of the first member 38 extending outward from the weld joint.

As illustrated in FIGS. 19 and 20, in one or more examples, the first guide surface 96 extends from a first end of the first interior surface 68 of the first side-stop 52 at an oblique angle (e.g., between approximately 15 degrees and approximately 60 degrees, such as approximately 45 degrees). In one or more examples, the first side-stop 52 also includes a third guide surface 120 that extends from a second end of the first interior surface 68 of the first side-stop 52 (opposite the first end) at an oblique angle (e.g., between approximately 15 degrees and approximately 60 degrees, such as approximately 45 degrees). The third guide surface 120 directs a portion of the molten metal 72, pushed or squeezed out from the welding volume 56, toward a side of an end of the first member 38 that extends beyond the weld joint.

Similarly, in one or more examples, the second guide surface 98 extends from a first end of the second interior surface 70 of the second side-stop 54 at an oblique angle (e.g., between approximately 15 degrees and approximately 60 degrees, such as approximately 45 degrees). In one or more examples, the second side-stop 54 also includes a fourth guide surface 122 that extends from a second end of the second interior surface 70 of the second side-stop 54 (opposite the first end) at an oblique angle (e.g., between approximately 15 degrees and approximately 60 degrees, such as approximately 45 degrees). The fourth guide surface 122 directs a portion of the molten metal 72, pushed or squeezed out from the welding volume 56, toward an opposing side of the end of the first member 38 that extends beyond the weld joint.

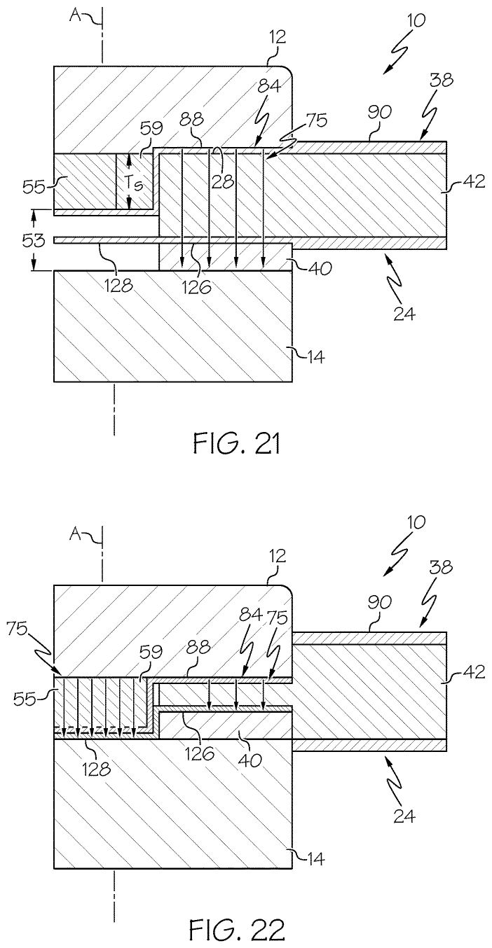

Referring now to FIGS. 21 and 22, which schematically illustrate an example of the welding assembly 10 and an example of the auxiliary member 84. The auxiliary member 84 may also be referred to as a weld cover. In one or more examples, the auxiliary member 84 includes or takes the form of the tube 88 (e.g., a tubular body with a hollow interior) of sufficient size and shape to surround (e.g., cover) the exterior surface 26 of a portion of the first member 38 (e.g., bare metal portion of the strands 42 of a stranded cable or wire). The tube 88 may have a circular cross-sectional shape, a rectangular cross-sectional shape, or other suitable cross-sectional shape. In one or more examples, the auxiliary member 84 may also include the split 92 extending the length of the tube 88 (e.g., as shown in FIGS. 8 and 16)

In one or more examples, the auxiliary member 84 has a length sufficient to extend past an end of the first member 38, such that a portion of the auxiliary member 84 is positioned within the gap 53 between the shunt member 55 and the second electrode 14 (e.g., as shown in FIG. 21). In one or more examples, the auxiliary member 84 also has a shape configured to accommodate the shunt member 55 when the welding assembly 10 is in the first position (e.g., as shown in FIG. 21).

In one or more examples, the tube 88 includes a body portion 126 extending along a longitudinal axis of the auxiliary member 84 and an extension portion 128 that extends from the body portion 126 along the longitudinal axis of the auxiliary member 84. The body portion 126 is configured to cover at least a portion of the end of the first member 38 (e.g., the bare strands 42). The extension portion 128 extends from the end of the first member 38 and is located between the shunt member 55 and the second electrode 14 (e.g., as shown in FIG. 21). The extension portion 128 does not contain the first member 38.

As illustrated in FIG. 21, when the welding assembly 10 is in the first position, the welding current 75 passes between the first electrode 12 and the second electrode 14, and through the body portion 126 of the auxiliary member 84, the first member 38, and the second member 40. The shunt member 55 is spaced away from (e.g., electrically isolated from) the second electrode 14 and the extension portion 128 of the auxiliary member 84 is spaced away from the second electrode 14 within the gap 53.

In one or more examples, when the welding assembly 10 is moved to the first position (e.g., as shown in FIG. 21), the shunt member 55 is configured to deform or partially compress the extension portion 128 of the auxiliary member 84, such that the auxiliary member 84 conforms to the profile shape of the shunt member 55 (and the electrically nonconductive member 59 when present)

In one or more examples, the extension portion 128 is configured or suitably shaped to accommodate the shunt member 55 when the welding assembly 10 is moved into the first position (e.g., as shown in FIG. 21). In one or more examples, the extension portion 128 has a cross-sectional dimension that is less than a cross-sectional dimension of the body portion 126.

In one or more examples, the extension portion 128 tapers inwardly, along the longitudinal axis of the auxiliary member 84, as it extends from the body portion 126 to accommodate the shunt member 55 when the welding assembly 10 is in the first position.

In one or more examples, at least a portion (e.g., an upper portion) of the extension portion 128 includes a contour or at least one bend (e.g., two bends shown in FIG. 21), such that a first portion of the extension portion 128 covers a portion of the end of the first member 38. A second portion of the extension portion 128 runs along (e.g., approximately parallel to) the shunt member 55 to accommodate the shunt member 55 when the welding assembly 10 is in the first position. In these examples, another portion (e.g., a lower portion) of the extension portion 128 extends from the body portion 126 and is parallel to the second electrode 14.

As illustrated in FIG. 22, when the welding assembly 10 is moved to the second position, the shunt member 55 is configured to clamp, compress, or crimp the extension portion 128 of the auxiliary member 84 together, such that the extension portion 128 of the auxiliary member 84 covers or encloses at least a portion of the end of the first member 38.

When the welding assembly 10 is in the second position (e.g., as shown in FIG. 22), at least a portion the welding current 75 bypasses body portion 126 of the auxiliary member 84, the first member 38, and the second member 40. As an example, a first portion (e.g., a majority) of the welding current 75 passes between the first electrode 12 and the second electrode 14, and through the shunt member 55 and the extension portion 128 of the auxiliary member 84. A second portion (e.g., a minority) of the welding current 75 passes between the first electrode 12 and the second electrode 14, and through the body portion 126 of the auxiliary member 84, the first member 38, and the second member 40.

The resulting welded workpiece 58 includes a step weld formed by the extension portion 128 of the auxiliary member 84 at the end of first member 38 and the end of the second member 40. As such, ends of the strands 42 of the first member 38 are contained within the extension portion 128 of the auxiliary member 84 in the welded joint. The step weld provides additional strength to the weld joint.

Referring again to FIG. 1, in another example, the method 200 includes the step of positioning 215 the workpiece 24. The workpiece 24 is positioned between the first electrode 12 and the second electrode 14. In one or more examples, the workpiece 24 is positioned within the welding volume 56 formed by the width-determining fixture 36 (e.g., between the first side-stop 52 and the second side-stop 54). In one or more examples, the step of positioning 215 represents, includes, or results from the steps of positioning 220, positioning 230, and positioning 235 shown in FIG. 1.

In one or more examples, the method 200 includes a step of moving 225 the first electrode 12 and the second electrode 14 toward each other. In one or more example, the first electrode 12 and the second electrode 14 are moved to position the welding assembly 10 (e.g., the first electrode 12 and the second electrode 14) in the first position (e.g., as shown in FIGS. 9-11, 15, 17 and 21). In one or more examples, the step of moving 225 results in or includes the steps of positioning 220 and positioning 230.

In one or more examples, according to the method 200, the step of passing 260 includes a step of passing the welding current 75 between the first electrode 12 and the second electrode 14 and through the workpiece 24. The welding current 75 begins to resistively heat the workpiece 24 to initiate a weld joint between the first member 38 and the second member 40.

In one or more examples, the method 200 includes a step of further moving 225 the first electrode 12 and the second electrode 14 toward each other. In one or more examples, the step of moving 225 results in the step of clamping 250. For example, the first electrode 12 and the second electrode 14 are further moved relative to each other to apply the welding force or clamping force (F1 and/or F2) to the workpiece 24, for example, while passing 260 the welding current 75 between the first electrode 12 and the second electrode 14 and through the workpiece 24.

In one or more examples, according to the method 200, the step of passing 260 includes a step of passing a first portion (e.g., a majority) of the welding current 75 directly between the first electrode 12 and the second electrode 14, thereby bypassing the workpiece 24 with the first portion of the welding current 75 and passing a second portion (e.g., a minority) of the welding current 75 through the workpiece 24.

In one or more examples, according to the method 200, the step of passing 260 the first portion of the welding current 75 directly between the first electrode and the second electrode includes or results from the step of positioning 240 the shunt member 55 between the first electrode 12 and the second electrode 14 and the step of moving 225 the first electrode 12 and the second electrode 14 into the second position (e.g., as shown in FIGS. 12-14 and 22), such that the shunt member 55 is in electrical communication with both the first electrode 12 and the second electrode 14. An electrical resistance of the shunt member 55 is less than an electrical resistance of the workpiece 24, thereby providing a lower resistance path to the welding current 75.

In one or more examples, the method 200 includes a step of electrically isolating the shunt member 55 from at least a portion of the workpiece 24, such as from the first member 38. In one or more examples, step of electrically isolating the shunt member 55 results from the step of positioning 245 the electrically nonconductive member 59 between the shunt member 55 and the workpiece 24 (e.g., the first member 38).

In one or more examples, the method 200 includes a step of electrically isolating at least a portion of the workpiece 24 (e.g., the first member 38) from the second electrode 14. In one or more examples, the step of electrically isolating at least a portion of the workpiece 24 results from the step of positioning 270 the second electrically nonconductive member 94 between the first member 38 of the workpiece 24 and the second electrode 14.

In one or more examples, the method 200 includes the step of containing 280 a first portion of the molten metal 72 within the weld volume 56 while passing 260 the welding current 75 through the workpiece 24 without inhibiting relative movement of the first electrode 12 and the second electrode 14. The method 200 also includes the step of directing 285 a second portion of the molten metal 72 outward from the welding volume 56 toward a portion of the workpiece 24, such as to the sides of the first member 38.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represent a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 2-22, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 2-22, referred to above, need be included in every example and not all elements, features, and/or components described herein are necessarily depicted in each illustrative example. Accordingly, some of the elements, features, and/or components described and illustrated in FIGS. 2-22 may be combined in various ways without the need to include other features described and illustrated in FIGS. 2-22, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 2-22, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 2-22, and such elements, features, and/or components may not be discussed in detail herein with reference to each of FIGS. 2-22. Similarly, all elements, features, and/or components may not be labeled in each of FIGS. 2-22, but reference numerals associated therewith may be utilized herein for consistency.

In FIG. 1, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIG. 1 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the welding method 200 and the welding assembly 10 have been shown and described, modifications may occur to those skilled in the art upon reading the specification. The present application includes such modifications and is limited only by the scope of the claims.

1. A method for welding comprising:
assembling a workpiece comprising a first member and a second member;
positioning a first electrode proximate the first member and a second electrode proximate the second member, the first electrode being moveable relative to the second electrode along a longitudinal axis;
positioning a shunt member between the first electrode and the second electrode;
clamping the workpiece between the first electrode and the second electrode; and
during the clamping, passing a welding current between the first electrode and the second electrode,
wherein, while the welding current is passing between the first electrode and the second electrode, the first electrode moves relative to the second electrode from at least a first position, wherein a gap is defined between the shunt member and the second electrode, to a second position, wherein the gap is closed and at least a portion of the welding current passes through the shunt member.

2. The method of claim 1, wherein the first member comprises a plurality of strands.

3. The method of claim 1, wherein at least 80% of the welding current passes through the shunt member when the first electrode is in the second position.

4. The method of claim 1, wherein at least 90% of the welding current passes through the shunt member when the first electrode is in the second position.

5. The method of claim 1, wherein the shunt member is electrical coupled with both the first electrode and the second electrode when the first electrode is in the second position, thereby yielding a lower resistance path for the welding current to pass from the first electrode to the second electrode as compared to the workpiece.

6. The method of claim 1, wherein the shunt member has an axial thickness relative to the longitudinal axis, and wherein the axial thickness is a function of the first member.

7. The method of claim 6, wherein the first member comprises a plurality of strands, and wherein the axial thickness is a function of an airspace defined by the plurality of strands.

8. The method of claim 1, wherein the workpiece is consolidated to an axial thickness after the passing, and wherein the axial thickness of the shunt member is approximately equal to the axial thickness of the workpiece after the passing.

9. The method of claim 1, wherein the first member comprises aluminum.

10. The method of claim 1, wherein the second member comprises at least one of brass, copper, and tin.

11. The method of claim 1, wherein the shunt member comprises an electrical resistance that is less than an electrical resistance of the workpiece.

12. The method of claim 1, wherein the shunt member is removably coupled to the first electrode.

13. The method of claim 1, wherein the shunt member is integral with the first electrode such that the first electrode and the shunt member are a single, monolithic body.

14. The method of claim 1, wherein the shunt member is suspended between the first electrode and the second electrode in the first position.

15. The method of claim 1, further comprising cooling at least one of the first electrode and the second electrode during the passing the welding current between the first electrode and the second electrode.

16. The method of claim 1, further comprising positioning an electrically nonconductive member between the shunt member and the workpiece.

17. The method of claim 16, wherein the electrically nonconductive member comprises a ceramic material.

18. The method of claim 16, wherein the electrically nonconductive member comprises silicon nitride.

19. The method of claim 16, further comprising positioning a second electrically nonconductive member between the first member of the workpiece and the second electrode.

20. The method of claim 1, further comprising providing a current generator, wherein the first electrode and the second electrode are electrically coupled with the current generator.

21. The method of claim 1, further comprising positioning the workpiece within a welding volume of a width-determining fixture, the welding volume having a width.

22. The method of claim 21, further comprising:
containing a first portion of molten metal between a first interior surface of a first side-stop of the width-determining fixture and a second interior surface of a second side-stop of the width-determining fixture, while passing the welding current between the first electrode and the second electrode; and
directing a second portion of the molten metal toward the first member of the workpiece using a first guide surface of the first side-stop and a second guide surface of the second side-stop.

23. The method of claim 1, further comprising zincating the first member prior to the assembling.

24. The method of claim 1, further comprising positioning an auxiliary member around at least a portion of the first member of the workpiece, wherein the auxiliary member comprises a tube having a split extending a length of the tube.

25. A welding assembly comprising:
a current generator;
a first electrode electrically coupled to the current generator;
a second electrode electrically coupled to the current generator; and
a shunt member located between the first electrode and the second electrode,
wherein the first electrode is moveable relative to the second electrode between at least a first position and a second position,
wherein the shunt member is electrically isolated from the second electrode when the first electrode is in the first position, and
wherein the shunt member is electrically coupled with both the first electrode and the second electrode when the first electrode is in the second position.

26-44. (canceled)

45. A method for welding comprising steps of:
positioning a workpiece between a first electrode and a second electrode;
moving the first electrode and the second electrode toward each other;
passing a welding current through the workpiece;
further moving the first electrode and the second electrode toward each other; and
passing a portion of the welding current directly between the first electrode and the second electrode.

46-49. (canceled)
